(19) United States
(12) Patent Application Publication
(10) Pub. No.: US 2024/0265747 A1
(43) Pub. Date: Aug. 8, 2024

(54) TIRE MANAGEMENT DEVICE, TIRE MANAGEMENT PROGRAM, AND TIRE MANAGEMENT METHOD

(71) Applicant: BRIDGESTONE CORPORATION, Tokyo (JP)

(72) Inventors: Takenori SANNOMIYA, Chuo-ku, Tokyo (JP); Kazutaka MATSUZAWA, Chuo-ku, Tokyo (JP)

(73) Assignee: BRIDGESTONE CORPORATION, Tokyo (JP)

(21) Appl. No.: 18/562,919

(22) PCT Filed: Aug. 16, 2022
(86) PCT No.: PCT/JP2022/030984

§ 371 Date: Nov. 21, 2023

(30) Foreign Application Priority Data
Aug. 23, 2021 (JP) 2021-135666

(51) Int. Cl. G07C 5/00; B60C 11/24; B60C 23/04; B64F 5/60

(52) U.S. Cl. CPC G07C 5/006; B60C 11/24; B60C 23/04; G07C 5/008; B64F 5/60

(57) ABSTRACT

A tire management device that acquires data indicating a worn state of each tire mounted on a mobile object including an aircraft or a vehicle, operation data of the mobile object, and internal pressure time-series data of a tire; calculates tire change time information for responding to a state in which a remaining groove depth of the tire is less than a preset threshold value, based on the data indicating the worn state and the operation data of the mobile object; calculates internal pressure filling time information for responding to a state in which an internal pressure is less than a predetermined threshold value, based on transition of the internal pressure time-series data; and instructs whether to perform maintenance on each tire, based on the calculated tire change time information and the calculated internal pressure filling time information.

### TECHNICAL FIELD

The present invention relates to a tire management device, a tire management program, and a tire management method that can be applied to a tire of a mobile object including an aircraft or a vehicle.

### BACKGROUND ART

When the wear amount of a tire or the like of an aircraft, which is a type of a mobile object, reaches a predetermined value, a tire changing operation is performed from the viewpoint of ensuring safety.

Conventionally, in order to perform this kind of tire changing operation efficiently, various techniques related to a tire management devices or the like for predicting the wear amount of a tire have been proposed (Patent Literature 1).

The techniques attempt to manage the wear amount of a tire and apprehend the appropriate time for performing a tire changing operation to perform the tire changing operation efficiently, ensure the safety of an aircraft and the like, and prevent the tire failure.

### CITATION LIST

### Patent Literature

PTL 1: Japanese Unexamined Patent Application Publication No. 2019-105600

### SUMMARY OF THE INVENTION

Incidentally, in the case of an aircraft tire and the like, from the viewpoint of ensuring safety, it is necessary to monitor internal pressure data, and to perform an internal pressure filling operation when an internal pressure is less than a predetermined threshold value.

However, there has been a problem that the conventional tire management device or the like cannot support the complex maintenance including an internal pressure filling operation in addition to the management of the wear amount.

This kind of problem is not limited to an aircraft tire, but the same applies to the management of various tires mounted on various mobile objects such as passenger cars, trucks, and buses.

The present invention has been devised in consideration of the above problem, and an object of the present invention is to provide a tire management device, a tire management program, and a tire management method that can support complex maintenance including internal pressure filling in addition to the management of the wear amount of a tire of a mobile object including an aircraft or a vehicle.

A tire management device according to an aspect of the present invention includes: a data acquiring unit that acquires data indicating a worn state of each tire mounted on a mobile object including an aircraft or a vehicle, operation data of the mobile object, and internal pressure time-series data of a tire; a tire change time information calculating unit that calculates tire change time information for responding to a state in which a remaining groove depth of the tire is less than a preset threshold value, based on the data indicating the worn state and the operation data of the mobile object; an internal pressure filling time information calculating unit that calculates internal pressure filling time information for responding to a state in which an internal pressure is less than a predetermined threshold value, based on transition of the internal pressure time-series data; and a maintenance instructing unit that instructs whether to perform maintenance on each tire, based on the calculated tire change time information and the calculated internal pressure filling time information.

As a result, the device can support the complex maintenance including internal pressure filling in addition to the management of the wear amount of a tire of a mobile object including an aircraft or a vehicle.

Further, if the tire change time information and the internal pressure filling time information are within a predetermined time period, the maintenance instructing unit may correct the tire change time information and the internal pressure filling time information to be identical and issue an instruction.

Accordingly, a tire changing operation and an internal pressure filling operation can be performed at the same time, and the operation efficiency can be enhanced.

In addition, with respect to each tire mounted on the same mobile object, if at least one of the tire change time information and the internal pressure filling time information is within a predetermined time period set in advance, the maintenance instructing unit may correct both the tire change time information and the internal pressure filling time information to be identical and issue an instruction.

Accordingly, a tire changing operation and an internal pressure filling operation can be performed at the same time, and the operation efficiency can be further enhanced.

Further, correction to make both the tire change time information and the internal pressure filling time information identical can be made based on the earlier time from between a time corresponding to the tire change time information and a time corresponding to the internal pressure filling time information.

Accordingly, a tire changing operation and an internal pressure filling operation can be performed efficiently.

Further, the tire management device may further include: a filled internal pressure calculating unit that, if a first time corresponding to the internal pressure filling time information is earlier than a second time corresponding to the tire change time information, calculates an internal pressure to be filled in the tire, based on a difference between the first time and the second time.

Accordingly, it is possible to calculate the optimum filled internal pressure for bringing out the performance of a tire.

Further, the filled internal pressure calculating unit may calculate an internal pressure to be filled in the tire, based on a ratio between a time period related to the difference between the first time and the second time and an internal pressure filling interval set in advance.

Accordingly, it is possible to calculate the optimum filled internal pressure for bringing out the performance of a tire.

A tire management program according to another aspect of the present invention is executed by a tire management device and includes the steps of: acquiring data indicating a worn state of each tire mounted on a mobile object including an aircraft or a vehicle, operation data of the mobile object, and internal pressure time-series data of a tire; calculating tire change time information for responding to a state in which a remaining groove depth of the tire is less than a preset threshold value, based on the data indicating the worn state and the operation data of the mobile object; calculating internal pressure filling time information for responding to a state in which an internal pressure is less than a predetermined threshold value, based on transition of the internal pressure time-series data; and instructing whether to perform maintenance on each tire, based on the calculated tire change time information and the calculated internal pressure filling time information.

Accordingly, it is possible to provide a tire management program that can support the complex maintenance including internal pressure filling, in addition to the management of the wear amount of a tire of a mobile object including an aircraft or a vehicle.

A tire management method according to another aspect of the present invention includes the steps of: acquiring data indicating a worn state of each tire mounted on a mobile object including an aircraft or a vehicle, operation data of the mobile object, and internal pressure time-series data of a tire; calculating tire change time information for responding to a state in which a remaining groove depth of the tire is less than a preset threshold value, based on the data indicating the worn state and the operation data of the mobile object; calculating internal pressure filling time information for responding to a state in which an internal pressure is less than a predetermined threshold value, based on transition of the internal pressure time-series data; and instructing whether to perform maintenance on each tire, based on the calculated tire change time information and the calculated internal pressure filling time information.

Accordingly, it is possible to provide a tire management method that can support the complex maintenance including internal pressure filling, in addition to the management of the wear amount of a tire of a mobile object including an aircraft or a vehicle.

According to the present invention, it is possible to provide a tire management device, a tire management program, and a tire management method that can support complex maintenance including internal pressure filling in addition to the management of the wear amount of a tire of a mobile object including an aircraft or a vehicle.

### BRIEF DESCRIPTION OF THE DRAWINGS

FIG. 1 is a functional block diagram showing a functional configuration of a tire management device according to an embodiment.

FIG. 2 is a schematic configuration diagram showing an example of the configuration of a tire to which the tire management device according to an embodiment is applied.

FIG. 3 is a flowchart showing an example of a processing procedure of tire management processing performed by the tire management device according to an embodiment.

### DESCRIPTION OF EMBODIMENT

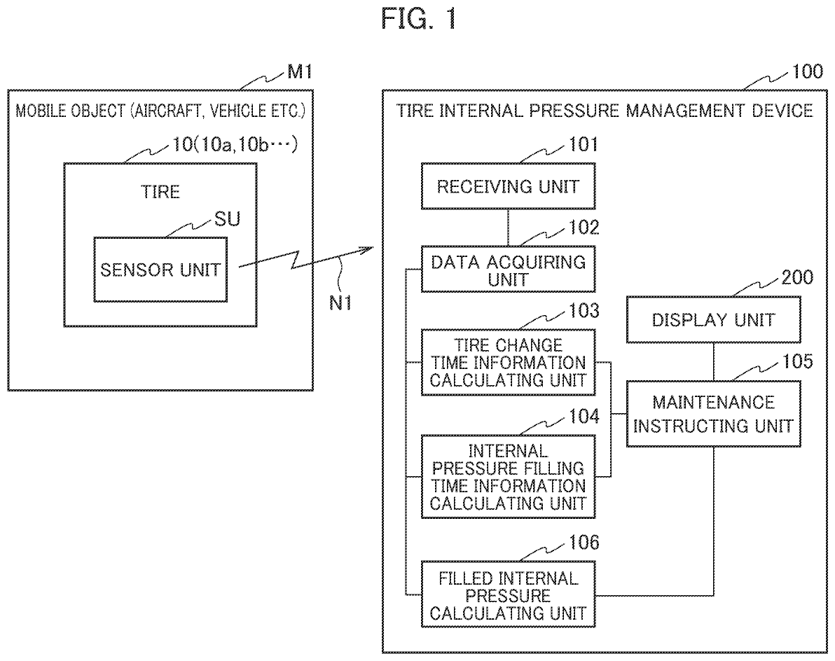

A tire management device 100 according to an embodiment of the present invention will be described with reference to FIGS. 1 to 3.

In the description of the drawings below, the same or similar parts are denoted with the same or similar reference numerals. However, it should be noted that the drawings are schematically shown and the ratios of dimensions and the like are different from those in reality.

Therefore, practical dimensions and the like should be determined by referring to the following description. Further, it is needless to say that the drawings include portions where the relationships and ratios of dimensions are different between drawings.

### (Schematic Configuration of Tire Management Device)

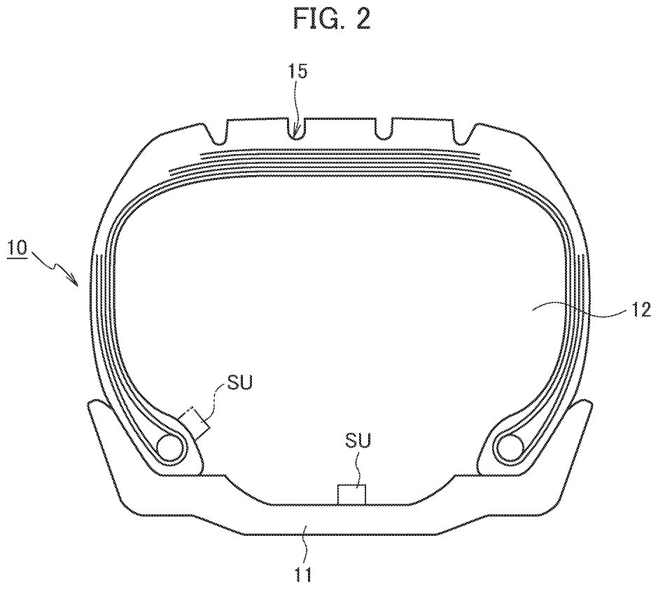

With reference to a functional block diagram of FIG. 1 and a schematic configuration diagram of FIG. 2, a description will be given regarding a schematic configuration of the tire management device 100 according to an embodiment.

The tire management device 100 is constituted by, for example, a general-purpose computer, a server, or the like, and as shown in FIG. 1, the tire management device 100 is configured to receive internal pressure data and the like from a sensor unit SU of each tire 10 (10a, 10b, and so forth) mounted on a mobile object M1 including an aircraft or a vehicle via a radio line N1.

As shown in FIG. 2, the tire 10 is mounted on a wheel 11 and forms a tire air chamber 12.

The sensor unit SU is disposed inside the wheel 11 or on an inner wall of the tire 10. It is needless to say that, depending on the type of mobile object M1, for example, an aircraft tire is used if the mobile object is an aircraft, and a vehicle tire is used if the mobile object is a vehicle.

As shown in FIG. 1, the tire management device 100 includes a receiving unit 101 for receiving internal pressure data and temperature data from the sensor unit SU having a transmission function via the radio line N1.

Further, the tire management device 100 includes a data acquiring unit 102 for acquiring data D1 indicating a worn state of each tire 10 (10a, 10b, and so forth), operation data D2 of the mobile object M1, and internal pressure time-series data D3 of the tire 10.

When the mobile object M1 is an aircraft, the operation data D2 corresponds to operation data of the aircraft.

Further, the tire management device 100 includes a tire change time information calculating unit 103 for calculating, based on the data D1 indicating a worn state and the operation data D2 of the mobile object M1, tire change time information d1 for responding to a state in which the remaining groove depth (for example, the depth of grooves 15 in a tread surface of the tire 10 shown in FIG. 2) of a tire is less than a preset threshold value.

The remaining amount data of the grooves 15 in the tire 10 may be actually measured or predicted by means of existing measurement techniques (for example, techniques disclosed in Japanese Unexamined Patent Application Publication No. 2019-105600 and Japanese Unexamined Patent Application Publication No. 2019-1055599). It is also possible to predict the life of each tire 10 (10a, 10b, and so forth) by periodically acquiring actual measurement data of a worn state of each tire 10 (10a, 10b, and so forth).

Further, the tire management device 100 includes an internal pressure filling time information calculating unit 104 which calculates, based on the transition of the internal pressure time-series data D3, internal pressure filling time information d2 for responding to a state in which an internal pressure is less than a predetermined threshold value.

Further, the tire management device 100 includes a maintenance instructing unit 105 for instructing whether to perform maintenance on each tire 10, based on the calculated tire change time information d1 and internal pressure filling time information d2, and a display unit 200 which is constituted by a liquid crystal display device or the like for displaying contents of the maintenance instruction.

Accordingly, the device can support complex maintenance including internal pressure filling, in addition to the management of the wear amount of the tire 10 of the mobile object M1 including an aircraft or a vehicle.

If the tire change time information d1 and the internal pressure filling time information d2 are within a predetermined time period, the maintenance instructing unit 105 can correct the tire change time information d1 and the internal pressure filling time information d2 to be identical and issue an instruction.

Accordingly, it is possible to perform a tire changing operation and an internal pressure filling operation at the same time, and the operation efficiency can be enhanced.

Further, the tire management device 100 includes a filled internal pressure calculating unit 106 for calculating, if the first time t1 corresponding to the internal pressure filling time information d2 is earlier than the second time t2 corresponding to the tire change time information d1, the internal pressure to be filled in the tire 10, based on the difference between the first time t1 and the second time (t1-t2 or t2-t1).

In addition, with respect to each tire 10 (10a, 10b, and so forth) mounted on the same mobile object M1, if at least one of the tire change time information d1 and the internal pressure filling time information d2 is within a predetermined time period set in advance, the maintenance instructing unit 105 can correct both the tire change time information d1 and the internal pressure filling time information d2 to be identical and issue an instruction.

Accordingly, it is possible to perform a tire changing operation and an internal pressure filling operation at the same time, and the operation efficiency can be further enhanced.

Further, the correction to make both time information identical can be made based on the earlier time from between the time corresponding to the tire change time information d1 and the time corresponding to the internal pressure filling time information d2.

Accordingly, it is possible to perform a tire changing operation and an internal pressure filling operation efficiently.

The filled internal pressure calculating unit 106 may calculate the internal pressure to be filled in the tire 10, based on the ratio between a time period related to the difference between the first time t1 and the second time t2 (t1-t2 or t2-t1), and an internal pressure filling interval set in advance.

Accordingly, a tire changing operation and an internal pressure filling operation can be performed efficiently.

In addition, if the tire change time information d1 and the internal pressure filling time information d2 are within a predetermined time period, the maintenance instructing unit 105 may correct the tire change time information d1 and the internal pressure filling time information d2 to be identical and issue an instruction.

Accordingly, the device can support complex maintenance including internal pressure filling, in addition to the management of the wear amount of the tire 10 of the mobile object M1 including an aircraft or a vehicle.

### (Tire Management Processing)

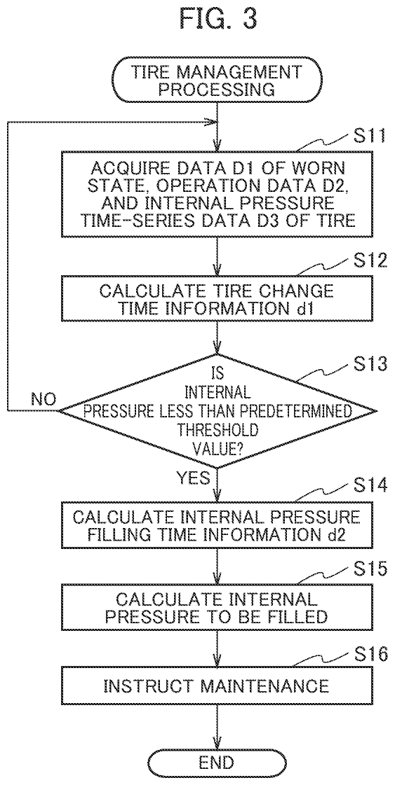

With reference to a flowchart of FIG. 3, a description will be given regarding an example of a processing procedure of tire management processing performed by the tire management device 100.

After the processing starts, first in step S11, the following are acquired: the data D1 indicating a worn state of each tire 10 (10a, 10b, and so forth) mounted on the mobile object M1 including an aircraft or a vehicle, the operation data D2 of the mobile object M1, and the internal pressure time-series data D3 of the tire 10, and then the processing moves to step S12.

In step S12, the tire change time information d1 for responding to a state in which the remaining groove depth of the tire 10 is less than a preset threshold value is calculated, based on the data D1 indicating a worn state and the operation data D2 of the mobile object M1, and the processing moves to step S13.

In step S13, it is determined whether the internal pressure is less than a predetermined threshold value, based on the transition of the internal pressure time-series data D3.

If the determination result is “No”, the processing returns to step S11, and alternatively if the determination result is “Yes”, the processing moves to step S14.

In step S14, the internal pressure filling time information d2 for responding to a state in which the internal pressure is less than a predetermined threshold value is calculated, and the processing moves to step S15.

In step S15, the internal pressure to be filled in the tire 10 is calculated. More specifically, if the first time t1 corresponding to the internal pressure filling time information 2 is earlier than the second time t2 corresponding to the tire change time information d1, the internal pressure to be filled in the tire 10 can be calculated based on the difference between the first time t1 and the second time t2.

The internal pressure to be filled in the tire 10 may be calculated based on the ratio between a time period related to the difference between the first time t1 and the second time t2, and an internal pressure filling interval set in advance

Next, in step S16, whether to perform maintenance on each tire 10 (10a, 10b, and so forth) is instructed based on the calculated tire change time information d1 and internal pressure filling time information d2, and the processing ends.

An instruction for maintenance can be made by means of notification by the display of a predetermined message or by means of voice output.

Accordingly, the device can support complex maintenance including internal pressure filling, in addition to the management of the wear amount of the tire 10 of the mobile object M1 including an aircraft or a vehicle.

The tire management device, a tire state estimating program, and a tire state estimating method of the present invention have been described based on the illustrated embodiment, but the present invention is not limited thereto, and the configuration of each unit can be replaced with any configuration having the same function.

For example, if the mobile object M1 is an aircraft, the internal pressure of a tire can be acquired by using a tire pressure monitoring system (TPMS) or an airframe sensor. Further, the internal pressure of a tire may be acquired by measuring after landing of an aircraft.

In addition, the internal pressure filling time information calculating unit 104 may be reset based on information indicating that a tire changing operation or an internal pressure filling operation has been performed.

### REFERENCE SIGNS LIST

M1 Mobile object (aircraft, vehicle, and the like)
100 Tire management device
10 (10a, 10b, and so forth) Tire
SU Sensor unit
101 Receiving unit
102 Data acquiring unit
103 Tire change time information calculating unit
104 Internal pressure filling time information calculating unit
105 Maintenance instructing unit
106 Filled internal pressure calculating unit
200 Display unit

1. A tire management device comprising:
a data acquiring unit that acquires data indicating a worn state of each tire mounted on a mobile object including an aircraft or a vehicle, operation data of the mobile object, and internal pressure time-series data of a tire;
a tire change time information calculating unit that calculates tire change time information for responding to a state in which a remaining groove depth of the tire is less than a preset threshold value, based on the data indicating the worn state and the operation data of the mobile object;
an internal pressure filling time information calculating unit that calculates internal pressure filling time information for responding to a state in which an internal pressure is less than a predetermined threshold value, based on transition of the internal pressure time-series data; and
a maintenance instructing unit that instructs whether to perform maintenance on each tire, based on the calculated tire change time information and the calculated internal pressure filling time information.

2. The tire management device according to claim 1, wherein
if the tire change time information and the internal pressure filling time information are within a predetermined time period, the maintenance instructing unit corrects the tire change time information and the internal pressure filling time information to be identical and issues an instruction.

3. The tire management device according to claim 1, wherein
with respect to each tire mounted on the same mobile object, if at least one of the tire change time information and the internal pressure filling time information is within a predetermined time period set in advance, the maintenance instructing unit corrects both the tire change time information and the internal pressure filling time information to be identical and issues an instruction.

4. The tire management device according to claim 2, wherein
correction to make both the tire change time information and the internal pressure filling time information identical is made based on the earlier time from between a time corresponding to the tire change time information and a time corresponding to the internal pressure filling time information.

5. The tire management device according to claim 1, further comprising:
a filled internal pressure calculating unit that, if a first time corresponding to the internal pressure filling time information is earlier than a second time corresponding to the tire change time information, calculates an internal pressure to be filled in the tire, based on a difference between the first time and the second time.

6. The tire management device according to claim 5, wherein
the filled internal pressure calculating unit calculates an internal pressure to be filled in the tire, based on a ratio between a time period related to the difference between the first time and the second time and an internal pressure filling interval set in advance.

7. A tire management program executed by a tire management device, the tire management program comprising the steps of:
acquiring data indicating a worn state of each tire mounted on a mobile object including an aircraft or a vehicle, operation data of the mobile object, and internal pressure time-series data of a tire;
calculating tire change time information for responding to a state in which a remaining groove depth of the tire is less than a preset threshold value, based on the data indicating the worn state and the operation data of the mobile object;
calculating internal pressure filling time information for responding to a state in which an internal pressure is less than a predetermined threshold value, based on transition of the internal pressure time-series data; and
instructing whether to perform maintenance on each tire, based on the calculated tire change time information and the calculated internal pressure filling time information.

8. A tire management method comprising the steps of:
acquiring data indicating a worn state of each tire mounted on a mobile object including an aircraft or a vehicle, operation data of the mobile object, and internal pressure time-series data of a tire;
calculating tire change time information for responding to a state in which a remaining groove depth of the tire is less than a preset threshold value, based on the data indicating the worn state and the operation data of the mobile object;
calculating internal pressure filling time information for responding to a state in which an internal pressure is less than a predetermined threshold value, based on transition of the internal pressure time-series data; and
instructing whether to perform maintenance on each tire, based on the calculated tire change time information and the calculated internal pressure filling time information.

9. The tire management device according to claim 3, wherein
correction to make both the tire change time information and the internal pressure filling time information identical is made based on the earlier time from between a time corresponding to the tire change time information and a time corresponding to the internal pressure filling time information.

10. The tire management device according to claim 2, further comprising:
a filled internal pressure calculating unit that, if a first time corresponding to the internal pressure filling time information is earlier than a second time corresponding to the tire change time information, calculates an internal pressure to be filled in the tire, based on a difference between the first time and the second time.

11. The tire management device according to claim 3, further comprising:
a filled internal pressure calculating unit that, if a first time corresponding to the internal pressure filling time information is earlier than a second time corresponding to the tire change time information, calculates an internal pressure to be filled in the tire, based on a difference between the first time and the second time.

12. The tire management device according to claim 4, further comprising:
a filled internal pressure calculating unit that, if a first time corresponding to the internal pressure filling time information is earlier than a second time corresponding to the tire change time information, calculates an internal pressure to be filled in the tire, based on a difference between the first time and the second time.
